(19) United States
(12) Patent Application Publication
(10) Pub. No.: US 2026/0244603 A1
(43) Pub. Date: Aug. 20, 2026

(54) AUTONOMOUS DATABASE MANAGEMENT SYSTEM

(71) Applicant: Nutanix, Inc., San Jose, CA (US)

(72) Inventor: Anil Madan, San Jose, CA (US)

(73) Assignee: Nutanix, Inc., San Jose, CA (US)

(21) Appl. No.: 19/646,961

(22) Filed: Apr. 14, 2026

Related U.S. Application Data
(63) Continuation of application No. 18/083,214, filed on Dec. 16, 2022, now Pat. No. 12,693,999.
(60) Provisional application No. 63/292,846, filed on Dec. 22, 2021.

(51) Int. Cl. G06F 16/21; G06F 9/50

(52) U.S. Cl. CPC G06F 16/21; G06F 9/5027; G06F 2209/501; G06F 2209/502; G06F 2209/505

(57) ABSTRACT

A database management system receives a user request for provisioning a database, autonomously selects a datacenter for provisioning the database based at least on a first pre-defined rule, autonomously selects at least one cluster in the datacenter based at least on a second pre-defined rule, determines a network location of each of the at least one cluster, and provisions the database on each of the at least one cluster using the network location of each of the at least one cluster.

### CROSS-REFERENCE TO RELATED APPLICATIONS

This application is a Continuation of U.S. Application No.: 18/083,214, filed December 16, 2022, which claims the benefit of and incorporates by reference U.S. Provisional Patent Application Serial No.: 63/292,846, filed on December 22, 2021, which applications are incorporated by reference herein in their entirety.

### BACKGROUND

Virtual computing systems are widely used in a variety of applications. Virtual computing systems include one or more host machines running one or more virtual machines and other entities (e.g., containers) concurrently. Modern virtual computing systems allow several operating systems and several software applications to be safely run at the same time, thereby increasing resource utilization and performance efficiency. However, the present-day virtual computing systems have limitations due to their configuration and the way they operate.

### SUMMARY

In accordance with some embodiments of the present disclosure, a method is disclosed. The method includes receiving, by a processor of a database management system, a user request for provisioning a database, autonomously selecting, by the processor, a datacenter for provisioning the database based at least on a first pre-defined rule, autonomously selecting, by the processor, at least one cluster in the datacenter based at least on a second pre-defined rule, determining, by the processor, a network location of each of the at least one cluster, and provisioning, by the processor, the database on each of the at least one cluster using the network of each of the at least one cluster.

In accordance with some embodiments of the present disclosure, a system is disclosed. The system includes a memory having computer-readable instructions stored thereon and a processor of a database management system executing the computer-readable instructions to receive a user request to provision a database, autonomously select a datacenter to provision the database based at least on a first pre-defined rule, autonomously select at least one cluster in the datacenter based at least on a second pre-defined rule, determine a network location of each of the at least one cluster, and provision the database on each of the at least one cluster using the network location of each of the at least one cluster.

In accordance with some embodiments of the present disclosure, a non-transitory computer-readable medium having computer-readable instructions stored thereon is disclosed. The computer-readable instructions when executed by a processor of a database management system cause the processor to: receive a user request to provision a database, autonomously select a datacenter to provision the database based at least on a first pre-defined rule, autonomously select at least one cluster in the datacenter based at least on a second pre-defined rule, determine a network location of each of the at least one cluster, and provision the database on each of the at least one cluster using the network location of each of the at least one cluster.

### BRIEF DESCRIPTION OF THE DRAWINGS

FIG. 1 is an example block diagram showing additional details of the database system of FIG. 1, in accordance with some embodiments of the present disclosure.

FIG. 2 is an example block diagram of a cluster of the database system of FIG. 1, in accordance with some embodiments of the present disclosure.

FIG. 3 is an example block diagram of an example database management system of the database system of FIG. 1, in accordance with some embodiments of the present disclosure.

FIG. 4 is an example flowchart outlining operations of the database management system of FIG. 3 in autonomously deciding a location for provisioning a database, in accordance with some embodiments of the present disclosure.

FIG. 5 is an example flowchart outlining operations of the database management system of FIG. 3 in autonomously selecting one or more clusters for a database, in accordance with some embodiments of the present disclosure.

FIG. 6 is an example flowchart outlining operations of the database management system of FIG. 3 in autonomously monitoring the suitability of a cluster for a particular database, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

The present disclosure is generally directed to a virtual computing system having a plurality of clusters, with each of the plurality of clusters having a plurality of nodes. Each of the plurality of nodes includes one or more virtual machines and other entities managed by an instance of a monitor such as a hypervisor. These and other components may be part of a datacenter, which may be managed by a user (e.g., an administrator or other authorized personnel). A distributed storage system, for providing storage and protection capabilities, is associated with the virtual computing system. The virtual computing system may be configured for providing database management services. For example, at least some of the one or more virtual machines within the virtual computing system may be configured as database virtual machines for storing one or more databases. These databases may be managed by a database management system. The database management system may provide a plurality of database services.

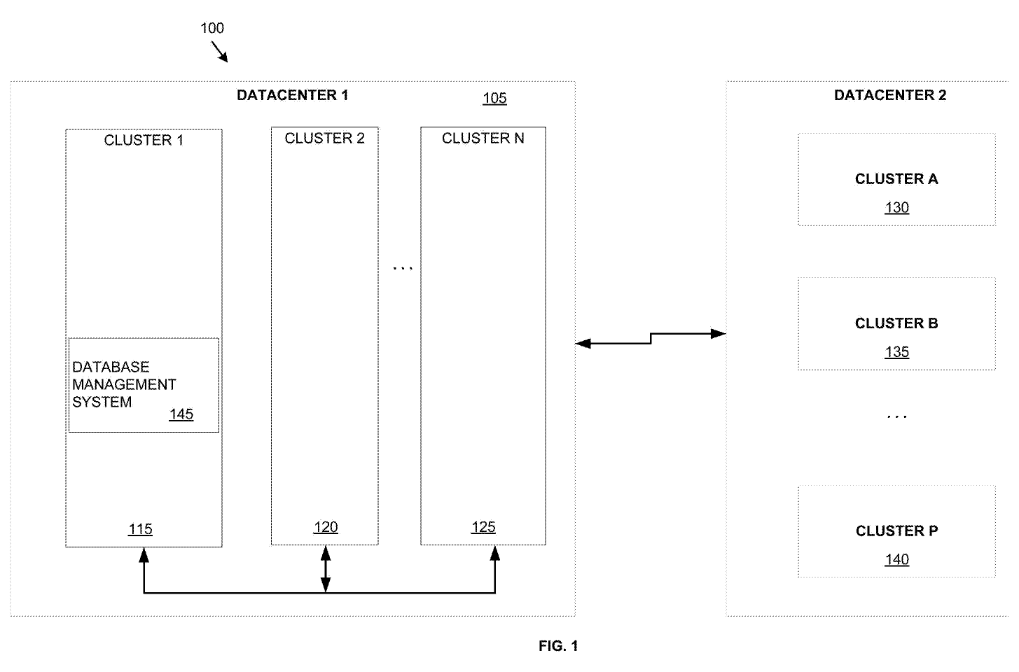

Referring to FIG. 1, an example block diagram of a database system 100 is shown, in accordance with some embodiments of the present disclosure. The database system 100 may be configured to manage databases spread across multiple clusters in a virtual computing system. In some embodiments, the multiple clusters may be spread across one or more datacenters of the virtual computing system. For example, and as shown in FIG. 1, the database system 100 may include a datacenter 105 and a datacenter 110. Although only two datacenters are shown in FIG. 1, the database system 100 may include a single datacenter or more than two datacenters.

Further, in some embodiments, either or both of the datacenter 105 and/or the datacenter 110 may be part of an on-premise environment. In other embodiments, either or both of the datacenter 105 and/or the datacenter 110 may be part of a cloud environment (e.g., public cloud, private cloud, hybrid cloud). In an “on-premise” environment, resources (e.g., databases) may be deployed locally (e.g., in-house) on an enterprise’s computers and servers, and be managed internally. In a cloud environment, resources (e.g., databases) may be hosted by a service provider and may be accessed via a network (e.g., the internet) using, for example, a web-based browser. In some embodiments, the service provider may be associated with the enterprise of the on-premise environment. In other words, in some embodiments, the cloud environment may be managed by the enterprise managing the on-premise environment. In some embodiments, the cloud environment may be managed by a third-party site provider. The cloud environment, may thus in some embodiments, be a public cloud (e.g., Amazon Web Services, Microsoft Azure, Google Cloud, etc.), a private cloud (e.g., cloud managed by a particular enterprise for their own use), or a hybrid cloud (e.g., a combination of public and private clouds).

Additionally, in some embodiments, the datacenters 105 and 110 may be geographically located in the same location, while in other embodiments, those datacenters may be in different geographical locations. For example, in some embodiments, the datacenters 105 and 110 may be located in the same or different cities, same or different states, same or different countries, same or different continents, etc. The term “geographical location” may be defined based on any physical features of an area. The database system 100 may, thus, be configured to manage databases stored in the datacenters 105 and 110. In some embodiments, the datacenter 105 and the datacenter 110 may be part of one or more availability zones and/or all-availability groups.

Each of the datacenters 105 and 110 may include one or more clusters. For example, the datacenter 105 may include clusters 115, 120, 125, while the datacenter 110 may include clusters 130, 135, 140. Although each of the datacenters 105 and 110 is shown as having three respective clusters, in other embodiments, each of those datacenters may have less than three or greater than three clusters. Further, although both the datacenters 105 and 110 have been shown as having an equal number of clusters, in some embodiments, those datacenters may have varying number of clusters.

Databases that are provisioned in the database system 100 may be located on one or more clusters in the datacenters 105 and/or 110. For example, a database may be located on one or more clusters of either the datacenter 105 or the datacenter 110. In some embodiments, a database may be located on one or more clusters of the datacenter 105, as well as on one or more clusters of the datacenter 110. For example, a first database may reside on a cluster of the datacenter 105 and a copy of the first database may reside on a cluster of the datacenter 110. In some embodiments, any changes made to one copy of the database may be automatically made (e.g., carried over, either synchronously or asynchronously) to the other copies of the database. In some embodiments, a database may be provisioned as an “n-node” database, meaning that the database is to be provisioned (e.g., created or registered) on n clusters. For example, to provision a 2-node database, the database may be provisioned on 2 clusters. The two clusters may be on the datacenter 105 only, the datacenter 110 only, or a combination of those datacenters (e.g., 1 cluster on each datacenter).

By virtue of being located in multiple datacenters (e.g., the datacenter 105 and/or the datacenter 110) and multiple environments (e.g., on-premise environment and/or cloud environment), the database system 100 provides high availability. If either of the datacenter 105 or the datacenter 110 goes down, the databases that are on both may be accessed from the other datacenter that may still be operational. Thus, the database system 100 may be considered to form an Always On Availability Group (AAG). The database system 100 may also allow the databases to be accessed from multiple locations, for example, for different purposes.

Further, the databases on the database system 100 may be managed by a database management system 145. In some embodiments, one instance of the database management system 145 may be configured to manage databases spread across not just multiple clusters of the same datacenter, but also across multiple datacenters and multiple environments (e.g., on-premise environment, cloud environment). In some embodiments, the database management system 145 may reside on one datacenter (e.g., the datacenter 105, as shown in FIG. 1) and may be configured to manage the databases located on the datacenter 105, as well as the datacenter 110. For example, the database management system 145 may be configured to manage databases (whether source, cloned, etc.) located on the clusters 115, 120, 125 of the datacenter 105. Similarly, the database management system 145 may be configured to manage databases (whether source, cloned, etc.) located on the clusters 130, 135, 140 of the datacenter 110. In other embodiments, the database management system 145 may be configured to manage databases that are located on the same datacenter as the database management system. Thus, in some embodiments, each datacenter may have an instance of a database management system to manage databases located on that datacenter. In some embodiments, such multiple instances of the database management systems may communicate with each other to facilitate management of the databases on the various datacenters.

In some embodiments, the database management system 145 may include a server (e.g., controller) that provides database management services (e.g., database provisioning, database protection, copy data management, database patching, etc.). In some embodiments, the database management system 145 may also include an agent located on each of the clusters 115-140 that facilitates communication between the server of the database management system and the databases residing on those clusters. In some embodiments, the database management system 145 may communicate with a user via an API and a dashboard, and be associated with a database storage system, as discussed in greater detail below.

By creating databases across multiple datacenters (e.g., the datacenters 105, 110) and having the database management system 145 manage those databases across the multiple datacenters, the database system 100 provides resiliency against datacenter and regional failures. The database system 100 also improves quality of service. For example, consider a database running on a datacenter (e.g., the datacenter 105) located in New York. If that database is being accessed by a user located in San Francisco, that user in San Francisco may experience a significant latency (e.g., network latency) while accessing the database located in New York. To improve performance, a cluster having a copy of the database may also be created in San Francisco (e.g., on the datacenter 110). Thus, by being able to create/register databases across multiple clusters and multiple datacenters, the database may be created/registered such that copies of the same database resides on two nodes (e.g., a two-node database) where one node is located in a cluster of the datacenter located in New York and the other node is located in a cluster of the datacenter located in San Francisco. Both nodes may be managed by the same instance of the database management system 145. Thus, by providing the ability to provision (e.g., create) databases across datacenters, while providing a single point of management of all those databases, users may access the database from the node closest to them for better quality of service.

Further, in some embodiments, cloned databases, copies of source databases, snapshots of the source and/or cloned databases, and/or transactional logs of the source and/or cloned databases may be stored in either or both of the datacenters 105 and 110 to provide high availability, back-up and restore capabilities, and to otherwise protect the databases.

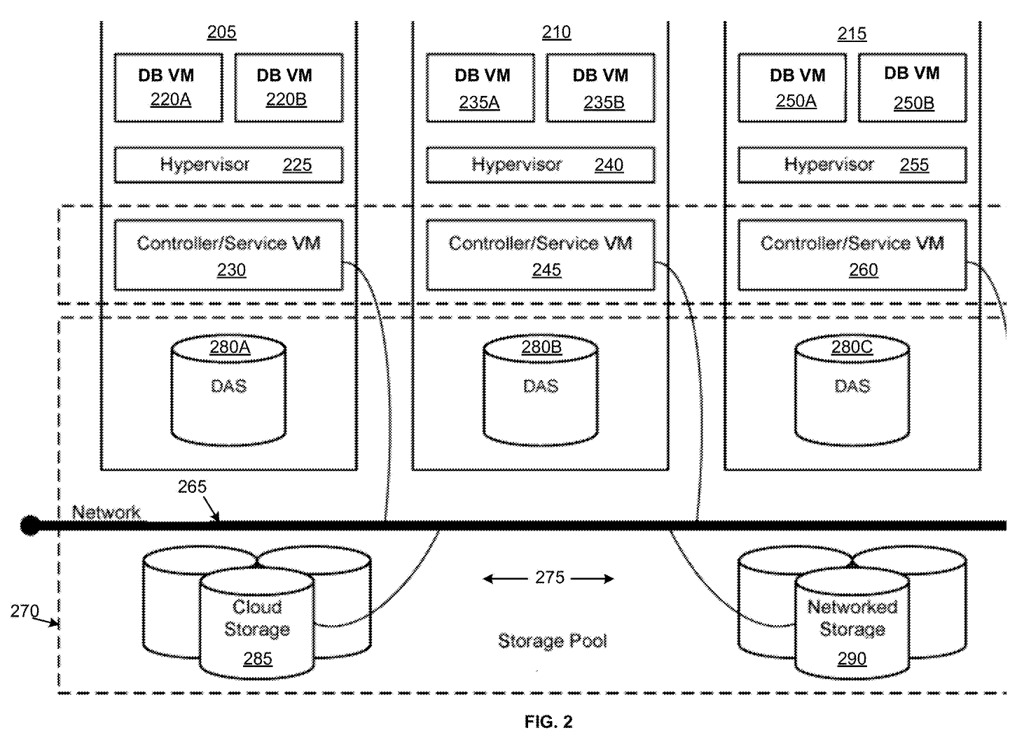

Referring now to FIG. 2, an example cluster 200 in a virtual computing system is shown, in accordance with some embodiments of the present disclosure. In some embodiments, the cluster 200 may be part of a hyperconverged system. In some embodiments, the cluster 200 may be part of an on-premise environment. In some embodiments, the cluster 200 may be part of a cloud environment (e.g., public cloud, private cloud, hybrid cloud). The cluster 200 may be a cluster on the datacenter 105 or the datacenter 110. Thus, in some embodiments, the cluster 200 may be any of the clusters 115-140. The cluster 200 may store databases and/or the database management system (e.g., the database management system 145, 145). The database management system is discussed in greater detail below.

The cluster 200 includes a plurality of nodes, such as a first node 205, a second node 210, and a third node 215. Each of the first node 205, the second node 210, and the third node 215 may also be referred to as a “host” or “host machine.” The first node 205 includes database virtual machines (“database VMs”) 220A and 220B (collectively referred to herein as “database VMs 220”), a hypervisor 225 configured to create and run the database VMs, and a controller/service VM 230 configured to manage, route, and otherwise handle workflow requests between the various nodes of the cluster 200. Similarly, the second node 210 includes database VMs 235A and 235B (collectively referred to herein as “database VMs 235”), a hypervisor 240, and a controller/service VM 245, and the third node 215 includes database VMs 250A and 250B (collectively referred to herein as “database VMs 250”), a hypervisor 255, and a controller/service VM 260. The controller/service VM 230, the controller/service VM 245, and the controller/service VM 260 are all connected to a network 265 to facilitate communication between the first node 205, the second node 210, and the third node 215. Although not shown, in some embodiments, the hypervisor 225, the hypervisor 240, and the hypervisor 255 may also be connected to the network 265. Further, although not shown, one or more of the first node 205, the second node 210, and the third node 215 may include one or more containers managed by a monitor (e.g., container engine).

The cluster 200 also includes and/or is associated with a storage pool 270 (also referred to herein as storage sub-system). The storage pool 270 may include network-attached storage 275 and direct-attached storage 280A, 280B, and 280C. The network-attached storage 275 is accessible via the network 265 and, in some embodiments, may include cloud storage 285, as well as a networked storage 290. In contrast to the network-attached storage 275, which is accessible via the network 265, the direct-attached storage 280A, 280B, and 280C includes storage components that are provided internally within each of the first node 205, the second node 210, and the third node 215, respectively, such that each of the first, second, and third nodes may access its respective direct-attached storage without having to access the network 265.

It is to be understood that only certain components of the cluster 200 are shown in FIG. 2. Nevertheless, several other components that are needed or desired in the cluster 200 to perform the functions described herein are contemplated and considered within the scope of the present disclosure.

Although three of the plurality of nodes (e.g., the first node 205, the second node 210, and the third node 215) are shown in the cluster 200, in other embodiments, greater than or fewer than three nodes may be provided within the cluster. Likewise, although only two database VMs (e.g., the database VMs 220, the database VMs 235, the database VMs 250) are shown on each of the first node 205, the second node 210, and the third node 215, in other embodiments, the number of the database VMs on each of the first, second, and third nodes may vary to include other numbers of database VMs. Further, the first node 205, the second node 210, and the third node 215 may have the same number of database VMs (e.g., the database VMs 220, the database VMs 235, the database VMs 250) or different number of database VMs.

In some embodiments, each of the first node 205, the second node 210, and the third node 215 may be a hardware device, such as a server. For example, in some embodiments, one or more of the first node 205, the second node 210, and the third node 215 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 205, the second node 210, or the third node 215 may be another type of hardware device, such as a personal computer, an input/output or peripheral unit such as a printer, or any type of device that is suitable for use as a node within the cluster 200. In some embodiments, the cluster 200 may be part of a data center. Further, one or more of the first node 205, the second node 210, and the third node 215 may be organized in a variety of network topologies. Each of the first node 205, the second node 210, and the third node 215 may also be configured to communicate and share resources with each other via the network 265. For example, in some embodiments, the first node 205, the second node 210, and the third node 215 may communicate and share resources with each other via the controller/service VM 230, the controller/service VM 245, and the controller/service VM 260, and/or the hypervisor 225, the hypervisor 240, and the hypervisor 255.

Also, although not shown, one or more of the first node 205, the second node 210, and the third node 215 may include one or more processing units or processors configured to execute instructions. The instructions may be carried out by a special purpose computer, logic circuits, or hardware circuits of the first node 205, the second node 210, and the third node 215. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 270, as well as with other elements of the first node 205, the second node 210, and the third node 215 to receive, send, and process information, and to control the operations of the underlying first, second, or third node. The processing units may retrieve a set of instructions from the storage pool 270, such as, from a permanent memory device like a read only memory (“ROM”) device and copy the instructions in an executable form to a temporary memory device that is generally some form of random access memory (“RAM”). The ROM and RAM may both be part of the storage pool 270, or in some embodiments, may be separately provisioned from the storage pool. In some embodiments, the processing units may execute instructions without first copying the instructions to the RAM. Further, the processing units may include a single stand-alone processing unit, or a plurality of processing units that use the same or different processing technology.

With respect to the storage pool 270 and particularly with respect to the direct-attached storage 280A, 280B, and 280C, each of the direct-attached storage may include a variety of types of memory devices that are suitable for a virtual computing system. For example, in some embodiments, one or more of the direct-attached storage 280A, 280B, and 280C may include, but is not limited to, any type of RAM, ROM, flash memory, magnetic storage devices (e.g., hard disk, floppy disk, magnetic strips, etc.), optical disks (e.g., compact disk (“CD”), digital versatile disk (“DVD”), etc.), smart cards, solid state devices, etc. Likewise, the network-attached storage 275 may include any of a variety of network accessible storage (e.g., the cloud storage 285, the networked storage 190, etc.) that is suitable for use within the cluster 200 and accessible via the network 265. The storage pool 270, including the network-attached storage 275 and the direct-attached storage 280A, 280B, and 280C , together form a distributed storage system configured to be accessed by each of the first node 205, the second node 210, and the third node 215 via the network 265, the controller/service VM 230, the controller/service VM 245, the controller/service VM 260, and/or the hypervisor 225, the hypervisor 240, and the hypervisor 255. In some embodiments, the various storage components in the storage pool 270 may be configured as virtual disks for access by the database VMs 220, the database VMs 235, and the database VMs 250.

Each of the database VMs 220, the database VMs 235, the database VMs 250 is a software-based implementation of a computing machine. The database VMs 220, the database VMs 235, the database VMs 250 emulate the functionality of a physical computer. Specifically, the hardware resources, such as processing unit, memory, storage, etc., of the underlying computer (e.g., the first node 205, the second node 210, and the third node 215) are virtualized or transformed by the respective hypervisor 225, the hypervisor 240, and the hypervisor 255, into the underlying support for each of the database VMs 220, the database VMs 235, the database VMs 250 that may run its own operating system and applications on the underlying physical resources just like a real computer. By encapsulating an entire machine, including CPU, memory, operating system, storage devices, and network devices, the database VMs 220, the database VMs 235, the database VMs 250 are compatible with most standard operating systems (e.g., Windows, Linux, etc.), applications, and device drivers. In some embodiments, one or more of the database VMs 220, the database VMs 235, the database VMs 250 maybe configured to host one or more databases. In some embodiments, one or more of the database VMs 220, the database VMs 235, the database VMs 250 may also be configured to host workloads other than or in addition to databases.

Each of the hypervisor 225, the hypervisor 240, and the hypervisor 255 is a virtual machine monitor that allows a single physical server computer (e.g., the first node 205, the second node 210, third node 215) to run multiple instances of the database VMs 220, the database VMs 235, and the database VMs 250 with each VM sharing the resources of that one physical server computer, potentially across multiple environments. For example, each of the hypervisor 225, the hypervisor 240, and the hypervisor 255 may allocate memory and other resources to the underlying VMs (e.g., the database VMs 220, the database VMs 235, the database VM 150A, and the database VM 150B) from the storage pool 270 to perform one or more functions. In other embodiments, other types of virtual machine monitors may be used.

By running the database VMs 220, the database VMs 235, and the database VMs 250 on each of the first node 205, the second node 210, and the third node 215, respectively, multiple workloads and multiple operating systems may be run on a single piece of underlying hardware computer (e.g., the first node, the second node, and the third node) to increase resource utilization and manage workflow. When new database VMs are created (e.g., installed) on the first node 205, the second node 210, and the third node 215, each of the new database VMs may be configured to be associated with certain hardware resources, software resources, storage resources, and other resources within the cluster 200 to allow those virtual VMs to operate as intended.

The database VMs 220, the database VMs 235, the database VMs 250, and any newly created instances of the database VMs may be controlled and managed by their respective instance of the controller/service VM 230, the controller/service VM 245, and the controller/service VM 260. The controller/service VM 230, the controller/service VM 245, and the controller/service VM 260 are configured to communicate with each other via the network 265 to form a distributed system 195. Each of the controller/service VM 230, the controller/service VM 245, and the controller/service VM 260 may be considered a local management system configured to manage various tasks and operations within the cluster 200. For example, in some embodiments, the local management system may perform various management related tasks on the database VMs 220, the database VMs 235, and the database VMs 250.

The hypervisor 225, the hypervisor 240, and the hypervisor 255 of the first node 205, the second node 210, and the third node 215, respectively, may be configured to run virtualization software, such as, ESXi from VMWare, AHV from Nutanix, Inc., XenServer from Citrix Systems, Inc., etc. The virtualization software on the hypervisor 225, the hypervisor 240, and the hypervisor 255 may be configured for running the database VMs 220, the database VMs 235, the database VM 150A, and the database VM 150B, respectively, and for managing the interactions between those VMs and the underlying hardware of the first node 205, the second node 210, and the third node 215. Each of the controller/service VM 230, the controller/service VM 245, the controller/service VM 260, the hypervisor 225, the hypervisor 240, and the hypervisor 255 may be configured as suitable for use within the cluster 200.

The network 265 may include any of a variety of wired or wireless network channels that may be suitable for use within the cluster 200. For example, in some embodiments, the network 265 may include wired connections, such as an Ethernet connection, one or more twisted pair wires, coaxial cables, fiber optic cables, etc. In other embodiments, the network 265 may include wireless connections, such as microwaves, infrared waves, radio waves, spread spectrum technologies, satellites, etc. The network 265 may also be configured to communicate with another device using cellular networks, local area networks, wide area networks, the Internet, etc. In some embodiments, the network 265 may include a combination of wired and wireless communications. The network 265 may also include or be associated with network interfaces, switches, routers, network cards, and/or other hardware, software, and/or firmware components that may be needed or considered desirable to have in facilitating intercommunication within the cluster 200.

Referring still to FIG. 2, in some embodiments, one of the first node 205, the second node 210, or the third node 215 may be configured as a leader node. The leader node may be configured to monitor and handle requests from other nodes in the cluster 200. For example, a particular database VM (e.g., the database VMs 220, the database VMs 235, or the database VMs 250) may direct an input/output request to the controller/service VM (e.g., the controller/service VM 230, the controller/service VM 245, or the controller/service VM 260, respectively) on the underlying node (e.g., the first node 205, the second node 210, or the third node 215, respectively). Upon receiving the input/output request, that controller/service VM may direct the input/output request to the controller/service VM (e.g., one of the controller/service VM 230, the controller/service VM 245, or the controller/service VM 260) of the leader node. In some cases, the controller/service VM that receives the input/output request may itself be on the leader node, in which case, the controller/service VM does not transfer the request, but rather handles the request itself.

The controller/service VM of the leader node may fulfil the input/output request (and/or request another component within/outside the cluster 200 to fulfil that request). Upon fulfilling the input/output request, the controller/service VM of the leader node may send a response back to the controller/service VM of the node from which the request was received, which in turn may pass the response to the database VM that initiated the request. In a similar manner, the leader node may also be configured to receive and handle requests (e.g., user requests) from outside of the cluster 200. If the leader node fails, another leader node may be designated.

Additionally, in some embodiments, although not shown, the cluster 200 may be associated with a central management system that is configured to manage and control the operation of multiple clusters in the virtual computing system. In some embodiments, the central management system may be configured to communicate with the local management systems on each of the controller/service VM 230, the controller/service VM 245, the controller/service VM 260 for controlling the various clusters.

Again, it is to be understood again that only certain components and features of the cluster 200 are shown and described herein. Nevertheless, other components and features that may be needed or desired to perform the functions described herein are contemplated and considered within the scope of the present disclosure. It is also to be understood that the configuration of the various components of the cluster 200 described above is only an example and is not intended to be limiting in any way. Rather, the configuration of those components may vary to perform the functions described herein.

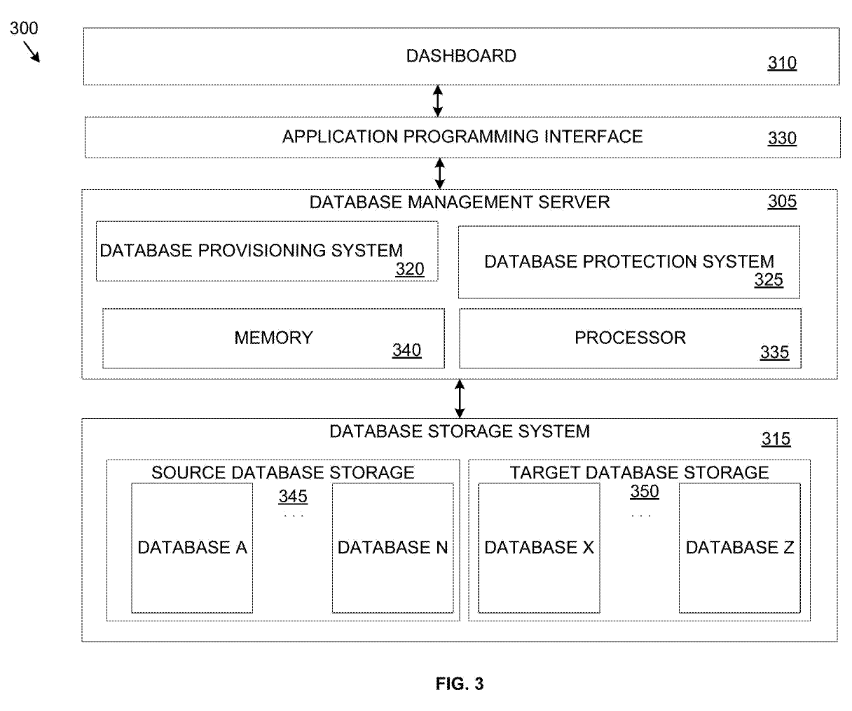

Turning now to FIG. 3, an example block diagram showing various details of a database management system 300 is shown, in accordance with some embodiments of the present disclosure. FIG. 3 is discussed in conjunction with FIGS. 1 and 2. The database management system 300 is analogous to the database management system 145. The database management system 300 or portions thereof may be configured as utility software for creating and implementing database management services. The database management system 300 is configured to facilitate provisioning (e.g., creation), registration, protection, querying, administration of the databases associated therewith, etc. In other words, the database management system 300 may be configured to provide a variety of database services or database management services related to the databases associated therewith. Thus, the database management system 300 includes a database management server 305 that is configured to receive input from and provide output to a user via a dashboard 310. The database management server 305 is also associated with a database storage system 315 that is configured to store one or more databases under management of the database management system 300. In association with the dashboard 310 and the database storage system 315, the database management server 305 is configured to implement one or more database management services of the database management system. For example, the database management server 305 is configured to provide database provisioning services to create new databases and register existing databases with the database management system 300 using a database provisioning system 320. The database management server 305 is also configured to protect databases created or registered by the database provisioning system 320 via a database protection system 325. Although the database provisioning system 320 and the database protection system 325 are shown as separate components, in some embodiments, the database provisioning system and the database protection system may be combined, and the combined component may perform the operations of the individual components. Although not shown, the database management server 305 may include other or additional components that provide other or additional database management services.

The database management system 300 may be installed on a database VM (e.g., the database VMs 220, the database VMs 235, the database VMs 250 of FIG. 2). The database management system 300 may be installed via the controller/service VM (e.g., the controller/service VM 230, the controller/service VM 245, the controller/service VM 260) of the node (e.g., the first node 205, the second node 210, and the third node 215) on which the database system is to be installed. For example, an administrator desiring to install the database management system 300 may download a copy on write image file (e.g., qcow or qcow2 image file) on the controller/service VM to define the content and structure of a disk volume to be associated with the database management system. In some embodiments, instead of a copy on write image file, another type of disk image file, depending upon the type of underlying hypervisor, may be installed. Further, the administrator may create or one or more new database VMs on which the database management system 300 is to reside. As part of creating the database VMs, the administrator may allocate a particular number of virtual central processors (vCPU) to each of the database VMs, define the number of cores that are desired in each vCPU, designate a specific amount of memory to each of the database VMs, and attach a database storage device (e.g., a virtual disk from the storage pool 270) with each of the database VMs. In some embodiments, at least a portion of the database storage device attached to the database management system 300 may form the database storage system 315. The administrator may also create a new network interface (e.g., associate a virtual local area network (VLAN), assign an Internet Protocol (“IP”) address to access the database management system 300, etc.) with each of the database VMs. The administrator may perform additional and/or other actions to create the database VMs on which the database system 100 resides upon creation and installation of the disk image file.

In some embodiments, the database VMs on which the database management system 300 resides may all be located on a single node (e.g., one of the first node 205, the second node 210, and the third node 215). In other embodiments, the database VMs on which the database management system 300 resides may be spread across multiple nodes within a single cluster, or amongst multiple clusters. When spread across multiple clusters, each of the associated multiple clusters may be configured to at least indirectly communicate with one another to facilitate operation of the database management system 300. Upon installing the database management system 300, a user (e.g., the administrator or other user authorized to access the database system) may access the dashboard 310. The dashboard 310, thus, forms the front end of the database management system 300 and the database management server 305 and the database storage system 315 form the backend of the database system.

The database management system 300 may be accessed via a computing device associated with the virtual computing system. In other embodiments, instead of or in addition to being accessible via a particular computing device, the database management system 300 may be hosted on a cloud service and may be accessed via the cloud. In some embodiments, the database management system 300 may additionally or alternatively be configured as a mobile application suitable for access from a mobile computing device (e.g., a mobile phone). In some embodiments, the database management system 300 and particularly the dashboard 310 may be accessed via an Application Programming Interface (“API”) 330. To access the dashboard 310 via the API 330, a user may use designated devices such as laptops, desktops, tablets, mobile devices, other handheld or portable devices, and/or other types of computing devices that are configured to access the API. These devices may be different from the computing device on which the database management system 300 is installed.

In some embodiments and when the dashboard 310 is configured for access via the API 330, the user may access the dashboard via a web browser and upon entering a uniform resource locator (“URL”) for the API such as the IP address of the database management system 300 or other web address. Using the API 330 and the dashboard 310, the users may then send instructions to the database management server 305 and receive information back from the database management server. In some embodiments, the API 330 may be a representational state transfer (“REST”) type of API. In other embodiments, the API 330 may be any other type of web or other type of API (e.g., ASP.NET) built using any of a variety of technologies, such as Java, .Net, etc., that is capable of accessing the database management server 305 and facilitating communication between the users and the database management server. In some embodiments, the API 330 may be configured to facilitate communication via a hypertext transfer protocol (“HTTP”) or hypertext transfer protocol secure (“HTTPS”) type request. The API 330 may receive an HTTP/HTTPS request and send an HTTP/HTTPS response back. In other embodiments, the API 330 may be configured to facilitate communication using other or additional types of communication protocols. In other embodiments, the database management system 300 may be configured for access in other ways.

The dashboard 310 provides a user interface that facilitates human-computer interaction between the users and the database management server 305. The dashboard 310 is configured to receive user inputs from the users via a graphical user interface (“GUI”) and transmit those user inputs to the database management server 305. The dashboard 310 is also configured to receive outputs/information from the database management server 305 and present those outputs/information to the users via the GUI of the management system. The GUI may present a variety of graphical icons, windows, visual indicators, menus, visual widgets, and other indicia to facilitate user interaction. In other embodiments, the dashboard 310 may be configured as other types of user interfaces, including for example, text-based user interfaces and other man-machine interfaces. Thus, the dashboard 310 may be configured in a variety of ways.

Further, the dashboard 310 may be configured to receive user inputs in a variety of ways. For example, the dashboard 310 may be configured to receive the user inputs using input technologies including, but not limited to, a keyboard, a stylus and/or touch screen, a mouse, a track ball, a keypad, a microphone, voice recognition, motion recognition, remote controllers, input ports, one or more buttons, dials, joysticks, etc. that allow an external source, such as the user, to enter information into the database system 100. The dashboard 310 may also be configured to present outputs/information to the users in a variety of ways. For example, the dashboard 310 may be configured to present information to external systems such as users, memory, printers, speakers, etc. Therefore, although not shown, dashboard 310 may be associated with a variety of hardware, software, firmware components, or combinations thereof. Generally speaking, the dashboard 310 may be associated with any type of hardware, software, and/or firmware component that enables the database management server 305 to perform the functions described herein.

Thus, the dashboard receives a user request (e.g., an input) from the user and transmits that user request to the database management server 305. In some embodiments, the user request may be to request a database management service. For example, in some embodiments, the user request may be to request a database provisioning service. In response to the user request for a database provisioning service, the database management server 305 may activate the database provisioning system 320.

The database management server 305, including the database provisioning system 320 and the database protection system 325 may be configured as, and/or operate in association with, hardware, software, firmware, or a combination thereof. Specifically, the database management server 305 may include a processor 335 configured to execute instructions for implementing the database management services of the database management system 300. In some embodiments, each of the database provisioning system 320 and the database protection system 325 may have their own separate instance of the processor 335. The processor 335 may be implemented in hardware, firmware, software, or any combination thereof. “Executing an instruction” means that the processor 335 performs the operations called for by that instruction. The processor 335 may retrieve a set of instructions from a memory for execution. For example, in some embodiments, the processor 335 may retrieve the instructions from a permanent memory device like a read only memory (ROM) device and copy the instructions in an executable form to a temporary memory device that is generally some form of random access memory (RAM). The ROM and RAM may both be part of the storage pool 270 and/or provisioned separately from the storage pool. In some embodiments, the processor 335 may be configured to execute instructions without first copying those instructions to the RAM. The processor 335 may be a special purpose computer, and include logic circuits, hardware circuits, etc. to carry out the instructions. The processor 335 may include a single stand-alone processor, or a plurality of processors that use the same or different processing technology. The instructions may be written using one or more programming language, scripting language, assembly language, etc.

The database management server 305 may also include a memory 340. The memory 340 may be provisioned from or be associated with the storage pool 270. In some embodiments, the memory 340 may be separate from the storage pool 270. The memory 340 may be any of a variety of volatile and/or non-volatile memories that may be considered suitable for use with the database management server 305. In some embodiments, the memory 340 may be configured to store the instructions that are used by the processor 335. Further, although not shown, in some embodiments, the database provisioning system 320 and the database protection system 325 may each, additionally or alternatively, have their own dedicated memory.

Further, the database management server 305 may be configured to handle a variety of types of database engine types. For example, in some embodiments, the database management server 305 may be configured to manage PostgreSQL, Oracle, Microsoft SQL server, and MySQL database engine types. In other embodiments, the database management server 305 may be configured to manage other or additional database engine types. Each database that is created within or registered with the database management system 300 may be of a particular “database engine type.” The database engine type may identify the type of database management system (e.g., Oracle, PostgreSQL, etc.) of a particular database. By virtue of creating or registering a database with a particular database engine type, that database is managed in accordance with the rules of that database engine type. Thus, the database management server 305 is configured to be operable with and manage databases associated with a variety of database engine types.

It is to be understood that only some components of the database management server 305 are shown and discussed herein. In other embodiments, the database management server 305 may also include other components that are considered necessary or desirable in implementing the various database management services discussed herein. Similarly, the database provisioning system 320 and the database protection system 325 may have components that are considered necessary or desirable in implementing the various database management services discussed herein.

Referring still to FIG. 3, the database storage system 315 is configured to store one or more databases that are either created within the database management system 300 or registered with the database system. The database storage system 315 may include a source database storage 345 and a target database storage 350. The source database storage 345 is configured to store the original instances of the databases (also referred to herein as source databases) that are created within or registered with the database management system 300. The target database storage 350 is configured to store the clones of the source databases (also referred to herein as cloned databases). In some embodiments, the source database storage 345 and the target database storage 350 may be provisioned from the storage pool 270 and may include virtual disk storage that is associated with the database VMs (e.g., the database VMs 220, the database VMs 235, the database VMs 250) on which the database system 100, the source databases, and the cloned databases reside. For example, in some embodiments, the source database storage 345 may be associated with one or more database VMs (referred to herein as source database VMs) and the source databases stored within the source database storage may be stored within the virtual disks associated with the source database VMs. Similarly, in some embodiments, the target database storage 350 may be associated with one or more database VMs (referred to herein as target database VMs) and the databases stored within the target database storage may be stored within the virtual disks associated with the target database VMs. In some embodiments, each source database VM may be configured to store one or more source databases and each target database VM may be configured to store one or more target databases. In other embodiments, the source database storage 345 and the target database storage 350 may additionally or alternatively be provisioned from other types of storage associated with the database system 100.

Further, depending upon the size of a particular database and the size of the virtual disk associated with a particular source database VM, a source database may be stored in its entirety on a single source database VM or may span multiple source database VMs. Further, as the size of that source database increases, the source database may be moved to another source database VM, may be stored onto multiple source database VMs, and/or additional storage may be provisioned to the source database VMs to house the increased size of the source database. Similarly, depending upon the size of a cloned database and the size of the virtual disk associated with a particular target database VM, the cloned database may be stored on a single or multiple target database VMs. Further, as the size of the cloned database increases (e.g., by virtue of updating the cloned database to incorporate any changes in the source database), the cloned database may be moved to another target database VM of appropriate size, may be divided amongst multiple target database VMs, and/or additional virtual disk space may be provisioned to the target database VM. Thus, the database storage system 315 is structured with the flexibility to expand and adapt to accommodate databases of various sizes.

Additionally, in some embodiments, the databases of the source database storage 345 and the target database storage 350 may be stored on a single cluster or span across multiple clusters. For example, in some embodiments, the databases of the source database storage 345 may span across a first set of clusters and the databases of the target database storage 350 may span across a second set of clusters. In some embodiments, the source databases and the cloned databases may be stored on separate designated clusters. In other embodiments, a cluster may be configured to store both source and cloned databases. In some embodiments, the cluster(s) on which the source databases are stored may be part of a single datacenter and/or availability zone, while in other embodiments, the cluster(s) on which the source databases are stored may be part of multiple datacenters and/or availability zones. Similarly, in some embodiments, the cluster(s) on which the cloned databases are stored may be part of a single datacenter and/or availability zone, while in other embodiments, the cluster(s) on which the cloned databases are stored may be part of multiple datacenters and/or availability zones. In some embodiments, multiple copies of the source databases and/or the cloned databases may be stored. Such multiple copies may be stored on the same cluster(s) on which the source databases or the cloned databases are stored, or may be stored on different cluster(s), and such cluster(s) may be part of the same datacenter and/or availability zone or part of different datacenters and/or availability zones. In some embodiments, at least some of the clusters on which the source databases, cloned databases, and/or copies of those databases are stored may be part of an on-premise environment, while at least some of the clusters on which the source databases, cloned databases, and/or copies of those databases are stored may be part of a cloud environment.

Additionally, it is to be understood that only some elements of the database management system 300 are shown herein. In other embodiments, the database management system 300 may include other or additional elements that may be needed or considered desirable to have in performing the functions described herein. For example, in some embodiments, the database management system 300 may include one or more agents, with each agent being stored on a cluster where a database is located or may be located.

In some embodiments, an agent may be an intermediary between the database management server 305 and the various databases on a particular cluster. In some embodiments, each agent may be configured as software, hardware, firmware, or a combination thereof. Each agent may, in some embodiments, be an autonomous software program that is configured for performing one or more specific and approved operations. Each agent may be associated with resources (e.g., CPU, memory, etc.) on the cluster that they reside on. In some embodiments, each agent may be installed on a virtual machine of the cluster that they reside on. In some embodiments, each agent may be configured to perform operations under control by the database management server 305.

The agents may interact with the database management server 305 to pick up work and execute. In other words, the database management server 305 may send requests or instructions to one or more agents for operations or tasks to be performed by those agents. Upon receiving the instructions from the database management server 305, one or more of the agents that receive those instructions may perform the requested tasks or operations by calling an appropriate script based on the type of work needed. For example, to create a clone of a database, an agent may invoke a cloning script. As another example, the agent may also be requested to gather transactional logs (also referred to herein as logs or log drives) for replicating and/or protecting databases. Upon completing their assigned task(s), the agents may respond back to the database management server 305 indicating that the tasks or operations are completed and wait to receive the next task or operation from the server. Example operations that each agent may perform may include database provisioning, database server provisioning (e.g., creating a database server virtual machine), database cloning, database server cloning (e.g., cloning a database server virtual machine), registering a database, registering a database server virtual machine, copy log operations, resiliency and curation operations, profile (e.g., network, software, compute, etc.) creation, capturing snapshots, cleanup operations, etc.

In some embodiments, each agent may have a process running thereon that may regularly (e.g., every 10 seconds) polls the database management server 305 for any tasks or operations to be performed. If the database management server 305 determines that a task or operation is needed, the server may send instructions to that polling agent. In some embodiments, the agents may poll the database management server 305 by calling an API on the database management server. In other embodiments, the agents may use other mechanisms to poll the database management server 305.

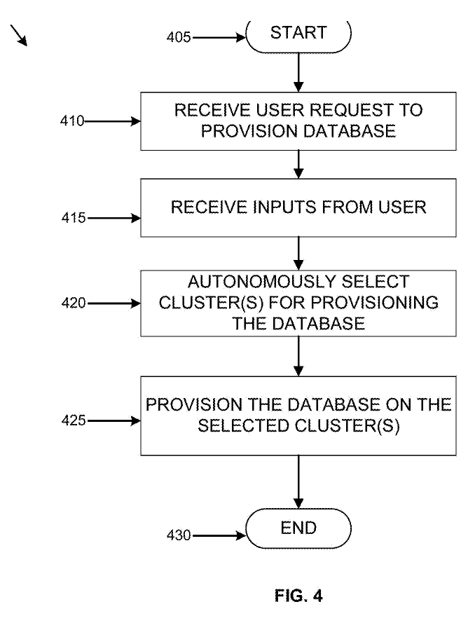

Turning now to FIG. 4, an example flowchart outlining operations of a process 400 is shown, in accordance with some embodiments of the present disclosure. The process 400 may include other or additional operations depending upon the particular embodiment. The process 400 may be used to provision/register (collectively referred to herein as “provision”) a database in the database system 100. Specifically, the process 400 may be used to autonomously select one or more clusters by the database management system 145 to provision the database. Although the process 400 is described with respect to database provisioning, in other embodiments, the process 400 may be used for other types of database management services that require the database management system 145 to select one or more clusters for performing the database management services. For example, in some embodiments, the process 400 may also be used for copy database management for protecting (e.g., cloning, backing up, restoring, etc.) database. When used for copy data management, in some embodiments, the process 400 may be used to autonomously select one or more clusters for cloning, backing up (e.g., replicating), restoring, etc. databases. Similarly, the process 400 may be used for other types of database management services in which selection of clusters is needed.

When provisioning a database, in some embodiments, a user may provide the identity (e.g., name, identifier, network location, etc.) of the cluster(s) (e.g., the datacenter 105 and/or the datacenter 110) where the user desires to provision the database. In some embodiments, the user selected clusters may not be entirely suitable for the database. For example, in some embodiments, the user may desire to provision a database of a certain size. If the user’s selected clusters do not have sufficient storage to host the database of that size, the performance of the database may suffer (e.g., increased latency, etc.) or the database may be created of a smaller than desired size. In some embodiments, the user may desire to create a database of a specific database engine type (e.g., SQL, postgres, etc.). The user’s selected clusters may not be optimal for that specific database engine type. For example, in some embodiments, each database engine type may require certain resources, protocols, processes, etc. for optimal performance. If the user’s selected clusters are not specifically configured for that specific database engine, the performance of the database may suffer (or worse, the database may be unable to be provisioned or be provisioned using a database engine type that the user may not desire).

In some embodiments, a cost of running a database on a user selected cluster may be more than the cost of running the database on another cluster. In some embodiments, the location of the user selected cluster may not be optimal. For example, if the user is located in New York, but selects a cluster located in San Francisco for provisioning the database, the performance of the database may suffer (e.g., have increased latency). Likewise, in other embodiments, the user’s selected clusters may not be optimal locations for hosting the database for other reasons.

Thus, in some embodiments, the database management system 145 (and particularly the database management server associated with the database management system) may be configured to autonomously select optimal clusters for provisioning a database. Specifically, in some embodiments, the database management system 145 may autonomously (e.g., without user input identifying the clusters) select one or more optimal clusters for provisioning a database. Upon starting at operation 405, the database management system 145 receives a user request to provision a database at operation 410. In some embodiments, the database management system 145 may receive the user request in any suitable way, for example, by way of a user interface (e.g., the dashboard 310). Again, although FIG. 4 is described for database provisioning, the process 400 may similarly be used for other database management services that require cluster selection.

Upon receiving the request to provision a database at the operation 410, the database management system 145 requests various parameters (e.g., inputs) from the user (e.g., via the dashboard 310) at operation 415. The types of input that the database management system 145 requests may depend upon the type of user request received at the operation 410. For example, in some embodiments, for a database provisioning user request, the database management system 145 may request a database engine type from the user that the user desires for the database being provisioned. In some embodiments, the database management system 145 may request a number of nodes (e.g., clusters) on which the database is to be provisioned. In some embodiments, the database management system 145 may request a size of the database that is desired. In some embodiments, the database management system 145 may also request a region in which the database is to be provisioned. In some embodiments, the database management system 145 may also request a name for the database and/or any other details that may be needed or desired to have in provisioning a database. In some embodiments, at a minimum, the database management system 145 may request a database engine type, a size of the database, and a region in which the database is to be provisioned for provisioning a database. In other embodiments, the database management system 145 may request other or additional inputs. In some embodiments, to request the inputs at the operation 415, the database management system 145 may present one or more user interfaces (e.g., via the dashboard 310) to the user.

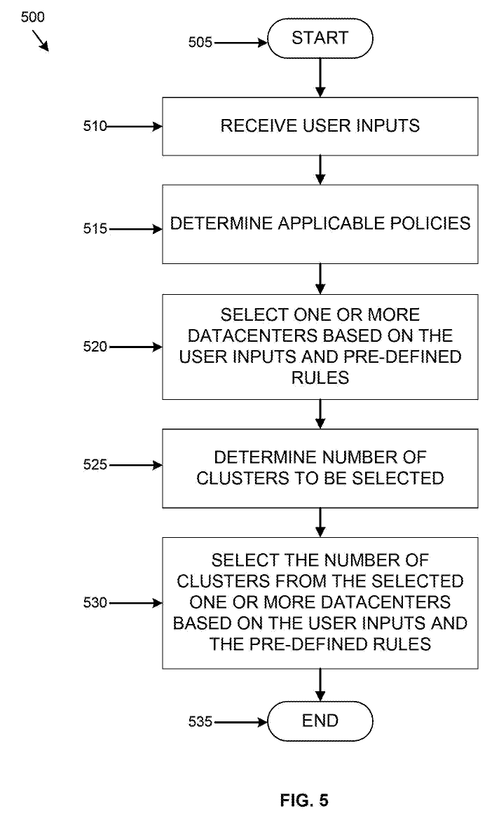

At operation 420, the database management system 145 autonomously selects one or more optimal clusters for provisioning the database. The selection is considered “autonomous” because the user does not identify the clusters on which the database is to be provisioned. Rather, the database management system 145 automatically selects the clusters on which the database is to be provisioned. In some embodiments, the database management system 145 may select the clusters based at least on the inputs received from the user at the operation 415. In some embodiments, the database management system 145 may also be pre-programmed with various criteria to help the database management system select the clusters. For example, in some embodiments, the criteria may be based upon the size of the database, the database engine type of the database, the type of cloud environment (e.g., public cloud, private cloud, hybrid cloud) properties of the cloud, storage availability, availability of computing resources (e.g., CPU processing, latency, input/output operations per second), region where the database is desired, policies applicable to the user, location of the user, cost of operating the database, etc. In some embodiments, the database management system 145 may apply similar criteria to select a datacenter on which to provision the database. In some embodiments, the criteria may be applied to the user inputs received at the operation 415, pre-defined rules, or a combination thereof. The autonomous selection of the clusters is discussed in greater detail in FIG. 5 below.

Thus, in some embodiments, the database management system 145 may autonomously select whether to provision the database in the datacenter 105 or the datacenter 110. In some embodiments, upon deciding whether to provision the database in the datacenter 105 or the datacenter 110, the database management system 145 may also autonomously select the clusters within the selected one of the datacenters on which to provision the database. For example, in some embodiments, the database management system 145 may first autonomously select the datacenter 105 to provision the database. Then, the database management system 145 may select one or more clusters in the datacenter 105 to provision the database. In some embodiments, the clusters that are selected (in either the datacenter 105 or the datacenter 110) may be selected from amongst those clusters that are already registered with the database management system 145. A cluster is considered “registered” with the database management system 145 when that cluster has been configured specifically for management by the database management system. Registration of clusters is described in greater detail in US Application No. 17/325,757, filed on May 20, 2021, the entirety of which is incorporated by reference herein.

Upon selecting the datacenter(s) and/or cluster(s) for provisioning the database at the operation 420, the database management system 145 provisions the database at each of the selected datacenter(s) and/or cluster(s) at operation 425. In some embodiments, the database management system 145 may create a new database server virtual machine for the database (or use an existing database server virtual machine) on the datacenter(s)/cluster(s) on which the database is to be provisioned. A database server virtual machine is a virtual machine on which the provisioned database resides. In other words, the database server virtual machine may be associated with a storage device (e.g., virtual disk(s)) and the provisioned database may be stored within that storage device and accessible via the database server virtual machine.

In some embodiments, to provision a database, the database management system 145 may need one or more profiles. For example, in some embodiments, for each cluster, the database management system 145 may need a software profile, a network profile, a compute profile, and/or a database parameter profile to provision a database. In some embodiments, the database management system 145 may use default profiles for provisioning the database. In other embodiments, the database management system 145 may have previously stored profiles that the user desires to use for one or more of the profiles. For example, in some embodiments, the database management system 145 may identify the profiles that the user has previously used for provisioning databases, and present those identified profiles to the user. The user may either select one or more of those profiles or provide one or more new profiles. In some embodiments, the database management system 145 may present profiles to the user based on other considerations. For example, in some embodiments, the database management system 145 may determine suitable profiles based on the inputs received from the user at the operation 410. In other embodiments, the database management system 145 may ask the user to provide the profiles without identifying any profiles for user review.

A software profile defines the software and operating system parameters for the database engine type that is desired. For example, if the database engine type is selected as PostgreSQL, the software profile may include one or more software and operations system image profiles associated with PostgreSQL. Each software profile may define the rules that are to be applied in managing the database being created. In some embodiments, based on the database engine type input by the user at the operation 415, the database management system 145 may be configured to select a software profile by default. In some embodiments, the user may have previously selected and stored one or more desired software profiles for each database engine type that the user may provision databases for. Thus, based on the user input of the operation 415 indicating the database engine type, the database management system 145 may select the software profile corresponding to that database engine type. In some embodiments, the same software profile may be replicated and applied to each cluster on which the database is to be provisioned. In other embodiments, the database management system 145 may use separate software profiles for each cluster.

A network profile identifies the network location of the cluster and/or the database server virtual machine on the cluster. In some embodiments, upon selecting the cluster(s) on which to provision the database on, the database management system 145 may obtain the network locations of those cluster(s) for the network profile. In other embodiments, the database management system 145 may select the network locations of the selected cluster(s) in other ways. In some embodiments, the database management system 145 may have previously stored network profiles selected by the user.

A compute profile defines the size/configuration of the database server. For example, the compute profile may define the number of vCPUs, number of cores per vCPU, and memory capacity to be associated with the database server. In other embodiments, the compute profile may define other or additional configurational parameters. In some embodiments, the compute profile may be replicated across the various clusters. In other embodiments, the database management system 145 may use separate compute profiles for each cluster on which the database is to be provisioned. In some embodiments, the database management system 145 may select a default compute profile (e.g., based on the size of the database being provisioned or other factors), while in other embodiments, the database management system may use a compute profile previously received from the user. The database parameter profile may define the custom parameters that are applied to the database being created. Again, in some embodiments, the database management system 145 may select a default database parameters profile or use a database parameters profile previously stored by the user. The database parameter profile may be replicated across the clusters, or the user may provide a separate profile for each cluster.

In other embodiments, the database management system 145 may receive selection of one or more of the above profiles from the user at the time of provisioning the database.

In some embodiments, the database management system 145 may also present one or more user interfaces, via the dashboard 310, to request selection of parameters for creating an instance of a database protection system (e.g., the database protection system 325) for the database being created by the process 400. In some embodiments, the database protection system may be created/associated after provisioning the database. The database protection system may also be referred to as a “time machine” and may be used to protect databases. To create a time machine, the database management system 300 may request a name and description for the time machine, a level of a Service Level Agreement (“SLA”), and a protection schedule to define rules based on which the time machine operates. Additional details of the time machine, as well as the process for provisioning a database, are described in U.S. Application No. 17/337,197, filed on June 2, 2021, the entirety of which is incorporated by reference herein.

To create the database, the database management system 145 may request one or more of the agents to perform one or more operations. In some embodiments, the database management system 145 may send the request to the agent(s) located on the cluster(s) identified at the operation 420. In some embodiments, the agent(s) may initiate a series of operations upon receiving the request from the database management system 145. For example, the agent(s) may create one or more database server virtual machines on the respective cluster, convert the database size into a number of virtual disks associated with that cluster and that are needed to house the database, create a database profile having a database name, description, network information, etc., attach the software and parameters of the database engine type with the database, optionally create an instance of the time machine, and associate the SLA and protection schedule with the database protection system, designate storage for storing snapshots and transactional logs, etc. Once the database is created, database management services (e.g., copy data management services) may be applied to the database. Further, when the database is created, the time machine starts capturing snapshots and transactional logs from the database.

The process 400 ends at operation 530. Thus, the process 400 provides an easy and convenient mechanism to not only provision a database but also to improve the performance of the database. By selecting optimal locations (e.g., clusters) for creating the database, the database management system 145 ensures that the database is hosted at a location that maximizes the performance of the database. Upon receiving a minimal amount of information from the user, the database management system 145 intelligently decides which cluster(s) to provision a database on, automatically determines one or more of the network, computer, software, or parameter profiles, and other details for provisioning the database.

Referring now to FIG. 5, an example flowchart outlining a process 500 is shown, in accordance with some embodiments of the present disclosure. The process 500 may include other or additional operations depending upon the particular embodiment. The process 500 may be implemented by the database management system 145 for autonomously selecting one or more clusters for performing a database management service (e.g., database provisioning). Upon starting at operation 505, the database management system 145 receives user inputs at operation 510. The inputs received at the operation 510 may be the same inputs that are received at the operation 415. At operation 515, the database management system 145 determines any applicable policies that may have been previously defined. In some embodiments, the database management system 145 store pre-defined rules that the database management system may consider in making the autonomous selection.

For example, in some embodiments, the pre-defined rules may specify a database engine type, a size of the database, whether the database is to be provisioned on the datacenter 105, datacenter 110, a public cloud, a private cloud, or a hybrid cloud, a number of nodes on which to provision the database, a location of the database (e.g., dependent on the location on the user), cost of operating the database, network latency, and any other criteria that may be needed or considered desirable to have for the database management system 145. In some embodiments, the pre-defined rules may be user specified. In other embodiments, the pre-defined rules may be default settings of the database management system 145. In other embodiments, the pre-defined rules may be a combination of default database management system settings and user defined rules. In some embodiments, no pre-defined rules may be used.

Based upon the user inputs of the operation 510 and/or the pre-defined rules of the operation 515, the database management system 145 selects one or more datacenters at operation 520. For example, in some embodiments, one of the user inputs at the operation 510 may specify a region in which the desired database is to be provisioned. At the operation 520, the database management system 145 may identify one or more suitable datacenters that fall within that region. For example, in some embodiments, if the user input specified a region of California, the database management system 145 may identify all datacenters that fall within the California region. In some embodiments, the region may be specified in the pre-defined rules. For example, in some embodiments, the pre-defined rules may specify provisioning a database in the North American region. In such cases, the database management system 145 may compare the pre-defined rules of the operation 515 with the user inputs of the operation 510 for any inconsistencies. Since California falls within the North American region, the database management system 145 may select the datacenters in California. Thus, in some embodiments, the database management system 145 may select the smaller or the more specific of the regions between the user inputs and the pre-defined rules (assuming the user inputs and pre-defined rules are not inconsistent).

In some embodiments, the pre-defined rules may be configured with a first region and the user inputs may desire a second region that does not overlap with the first region. For example, in some embodiments, the user may desire to provision a database in London and the pre-defined rules may specify a region of North America. Since London does not fall within North America, the database management system 145 may be configured to select either London or North America as the region. In some embodiments, the database management system 145 may be configured to prioritize the pre-defined rules during inconsistencies. In such cases, the database management system 145 may select North America as the region and identify suitable datacenters in North America. In some embodiments, the database management system 145 may issue a notification to the user informing that the database cannot be provisioned in London due to conflict with the pre-defined rules. In other embodiments, the database management system 145 may be configured to prioritize user inputs. In such cases, the database management system 145 may be configured to select London as the region and identify suitable datacenters in London.

In other embodiments, the database management system 145 may select the datacenters using other or additional criteria. For example, in some embodiments, the database management system 145 may select the datacenter that is closer to the location from where the database is to be accessed or where network latency is expected to be below a particular threshold. In some embodiments, the database management system 145 may select a datacenter based on a cost of operating the database at that datacenter. For example, in some embodiments, the database management system 145 may select a lower cost datacenter. In some embodiments, the database management system 145 may communicate with a cost estimation tool that provides an estimated cost of operating the database on various datacenters. Based on the cost estimate received from the cost estimation tool, the database management system 145 may select a suitable datacenter. In some embodiments, the user inputs and/or the pre-defined rules may indicate whether to provision the database on cloud, and particularly public, private, or hybrid cloud, or on-premise. The database management system 145 may then select a datacenter accordingly.

In some embodiments, upon identifying suitable datacenters, the database management system 145 may determine if the pre-defined rules specifically request provisioning databases on cloud or on-premise. For example, if the database management system 145 determines that the pre-defined rules specify provisioning databases on cloud, the database management system may select the datacenters in the appropriate region (e.g., London, California, etc.) that are part of the cloud environment. If the pre-defined rules do not specify a preference between on-premise and cloud, the database management system 145 may use other criteria to decide between on-premise and cloud. In some embodiments, the criteria to select specific clusters may result in the selection of on-premise or cloud, as discussed below.

Thus, at the operation 520, the database management system 145 identifies one or more suitable datacenters on which the database may be provisioned. At operation 525, the database management system 145 determines the number of clusters on which the database is to be provisioned. In some embodiments, the user inputs received at the operation 510 may define the number of clusters on which the database is to be provisioned. In other embodiments, the pre-defines rules may specify the number of nodes on which to provision the database. In some embodiments, if the user defined rules are consistent with the pre-defined rules, the database management system 145 may select the number of nodes received via the user inputs. For example, if the user desires to provision a 2-node database and the pre-defined rules indicate allowing the user to provision a database of no more than 4 nodes, since the user requested 2 nodes is a subset of the 4 nodes specified in the pre-defined rules, the database management system 145 may provision the database on 2 nodes (e.g., 2 clusters). In contrast, if the user inputs are inconsistent with the pre-defined rules, the database management system 145 may be configured to make a decision. For example, in some embodiments, the database management system 145 may be configured to prioritize the user inputs. In such cases, the database management system 145 may select the number of nodes specified in the user inputs regardless of the indication in the pre-defined rules.

On the other hand, if the database management system 145 is configured to prioritize the pre-defined rules, the database management system may select the number of nodes based on the pre-defined rules. For example, if the user desires a 3-node database and the pre-defined rules indicate no more than a 2-node database, the database management system 145 may select no more than 2 nodes for provisioning the database. The database management system 145 may be further configured with a default number to use within the constraint of the pre-defined rules in such cases. For example, since the pre-defined rules indicate no more than 2 nodes in the example above, the database management system 145 may select either a single node or two nodes to provision the database based on any default values pre-programmed therein. In other embodiments, the database management system 145 may be configured to select the number of clusters in other ways.

Further, in some embodiments, the operations 520 and 525 may be performed in any order or even simultaneously. At operation 530, the database management system 145 selects one or more clusters for provisioning the database. For example, if at the operation 525, the database management system 145 identified two clusters (e.g., for provisioning a 2-node database), then the operation 530 is configured to select two clusters in the one or more datacenters identified at the operation 520. The autonomous selection of the one or more clusters (e.g., the two clusters in the example above) may be based on one or more criteria applied to the user inputs and/or the pre-defined rules.

In some embodiments, size of the database may be a criteria for selecting the one or more clusters. As an example, the database management system 145 may determine (e.g., from user input or pre-defined rules) the size of the database to be provisioned. In some embodiments, at the operation 510, the user may specify a desired size of the database. In some embodiments, a size of the database may be specified in the pre-defined rules. In some embodiments, the database management system 145 may be further configured with a default size of the database. The database management system 145 may compare the size of the database in the user input and the size of the database in the pre-defined rules to decide a size of the database. As discussed above, in some embodiments, the size of the database in the user input may be consistent with (e.g., same as or a subset of) the size defined in the pre-defined rules. If so, the database management system 145 may select the size defined in the user input. If inconsistent, depending upon whether the user input or the pre-defined rules are prioritized higher, the database management system 145 may select the size noted in the higher prioritized one of the user input or the pre-defined rules. In some embodiments, if the pre-defined rules are selected but those rules don’t specify a specific size (e.g., provide a size range instead), the database management system 145 may use the default size of the database or other use other criteria to decide on the specific size while remaining within the range of the pre-defined rules.

Upon selecting the size of the database, at the operation 525, the database management system 145 may identify one or more suitable clusters in the one or more datacenters identified at the operation 520 having sufficient space availability for provisioning a database of the selected size. In some embodiments, the database management system 145 may add a buffer to the selected size to obtain a preferred size of the database. The buffer may be a space of a pre-determined size to allow the database to increase in size without running into space constraints. The database management system 145 may then identify one or more clusters that have sufficient space availability for the database of the preferred size (e.g., desired size + buffer size).

In some embodiments, database engine type may be another criteria in selecting the one or more clusters. For example, in some embodiments, the user may specify a desired database engine type at the operation 510 for the database. In some embodiments, database engine type of the database may be specified in the pre-defined rules. In some embodiments, the database management system 145 may be further configured with a default database engine type of the database. The database management system 145 may compare the database engine type of the database in the user input and the database engine type of the database in the pre-defined rules to decide a database engine type of the database. In some embodiments, the database engine type of the database in the user input may be consistent (e.g., same as) with the database engine type defined in the pre-defined rules. If so, the database management system 145 may select the database engine type defined in the user input. If inconsistent (e.g., the user input and the pre-defined rules have different database engine types), depending upon whether the user input or the pre-defined rules are prioritized higher, the database management system 145 may select the database engine type noted in the higher prioritized one of the user input or the pre-defined rules. Upon determining the database engine type, the database management system 145 may select one or more clusters that are configured for the determined database engine type.

Similarly, the database management system 145 may apply other or additional criteria in selecting the desired number of clusters in the one or more suitable datacenters. Further, in some embodiments, the database management system 145 may be configured to apply a single criterion in deciding the one or more clusters. In other embodiments, database management system 145 may be configured to apply multiple criteria in deciding the one or more clusters. In some embodiments, and particularly in those embodiments in which multiple criteria are used, the multiple criteria may be ranked in an order of priority such that criterion having a higher priority is applied before a lower priority criterion. For example, if the criteria is based on a size of the database and the database engine type, with the database engine type having a higher priority than the database size, then database management system 145 may first identify one or more first clusters that are suitable for the database engine type. Then, the database management system 145 may apply the database size criteria to the one or more first clusters to identify one or more second clusters that satisfy the database size criteria. If database management system 145 is unable to find the number of desired clusters that satisfy both criteria, the database management system may then attempt to find one or more clusters that satisfy the database engine type criterion since the database engine type criterion is higher ranked then the database size criteria.

For example, if the database management system 145 is attempting to identify two clusters and the criteria is prioritized as above (e.g., database engine type being ranked higher priority than database size), the database management system may first attempt to identify clusters that satisfy both the criteria of size and database engine type. Say, the database management system 145 finds one cluster that satisfies both criteria. For the remaining cluster, the database management system may then identify a cluster that satisfies the database engine type criteria (since it is ranked higher). If the database management system does not find a cluster that satisfies the database engine type criteria, then the database management system may either only provision a one node database or provision the database on another a cluster configured for another database engine type but that satisfies the database size criteria.

Thus, at the operation 530, the database management system 145 identifies one or more suitable clusters in the one or more suitable datacenters. The selection of the one or more suitable datacenters and the one or more suitable clusters in the one or more suitable datacenters may be based on user input, pre-defined rules, and/or default values stored within the database management system. Although the process 500 is described for provisioning, the process 500 may be applied for other types of database management services using the user inputs suitable for that type of database management service and the pre-defined rules. The process 500 ends at operation 535.

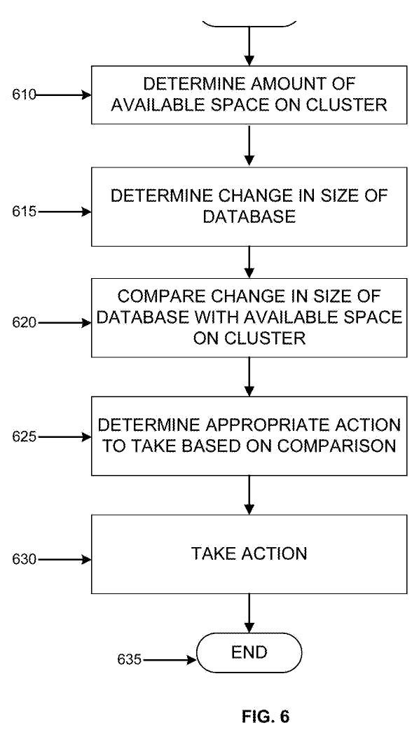

Turning now to FIG. 6, an example flowchart outlining operations of a process 600 is shown, in accordance with some embodiments of the present disclosure. The process 600 may include other or additional operations depending upon the particular embodiment. In some embodiments, as a database that was created using the process 400 is used, the size of that database may change from the size when the database was originally created. For example, as more data is stored is within the database, the size of the database may increase. Thus, in some embodiments, although the database may have been provisioned with a size A, the size of that database may change to a size B, which may be greater than the size A. In such cases, although the cluster on which the database is located may have been an optimal location for the database at the time of provisioning, due to the growing size of the database, that cluster may no longer be an optimal location for the database. In other embodiments, the cluster on which the database has been provisioned may become non-optimal for other reasons. For example, in some embodiments, the cost of operating the database on that cluster may become higher. In some embodiments, the network latency of operating the database may become higher. In some embodiments, the available resources on the cluster may change making the cluster sub-optimal.

The process 600 may be used to monitor the database and the cluster, and take action based on the monitoring. For example, the process 600 may be used to monitor the size of the database and take action based on a pattern of database usage and available space on the cluster. While the process 600 has been described based on monitoring a size of the database, in other embodiments, the process 600 may be applied for other conditions of the database and/or the cluster being monitored. In some embodiments, the process 600 may be implemented by the database management system 145 (and particularly by the database management server associated with the database management system).

Thus, the process 600 starts at operation 605 with the provisioning of a database on one or more clusters, as discussed in the process 400 above. At operation 610, the database management system 145 continues to monitor the amount of space available on the cluster on which the database is located. In some embodiments, the database management server of the database management system 145 may send one or more operations to the agent located on the cluster on which the database is hosted. The agent may continuously or periodically check the current amount of storage on the cluster. Since the cluster may host other databases or applications, the amount of space on the cluster may change even if the size of the database is not changing. Upon detecting a change in the amount of space on the cluster, the agent may send the information to the database management server. In some embodiments, the agent may be configured to reach out to the database management server only if the amount of space on the cluster reduces or reduces by a certain threshold. In some embodiments, the agent may be configured to reach out to the database management server upon identifying any change in the amount of space available on the cluster.

At operation 615, the database management system 145 also monitors a pattern of usage of the database. Specifically, the database management system 145 may monitor a pattern of how the size of the database changes. In some embodiments, the database management server of the database management system 145 may send one or more operations to the agent of the cluster on which the database is hosted to monitor the change in size of the database relative to the original size of the database when the database was provisioned. In some embodiments, when the agent detects a change in the size of the database (e.g., a change greater than a predetermined threshold), the agent may notify the database management server. Thus, through the agent, the database management server monitors both – the current size of the database, including the change in size, and the amount of space available on the cluster on which the database is located. In some embodiments, by virtue of continuously monitoring the size of the cluster and the size of the database, the database management system 145 may determine a pattern of how the size of the cluster changes and how the size of the database changes.

At operation 620, the database management system 145 compares a current size of the cluster (e.g., amount of space on the cluster) with the current size of the database. Specifically, at the operation 620, the database management system 145 determines if the cluster is still suitable for the database. In some embodiments, if the database management system 145 determines that the amount of space on the cluster is less than a pre-defined percentage, the database management system may determine that the cluster is no longer suitable for the database. In some embodiments, the database management system 145 may compare a pattern of usage of the database with the amount of space available on the cluster. For example, if the database management system 145 determines that the size of the database is changing at a rate of X% and that the database is expected to run out of space on the cluster based on the current amount of space on the cluster, the database management system may determine that the cluster is soon going to become unsuitable for the database. Upon determining that the cluster has become unsuitable or is expected to become unsuitable for the database, at operation 625, the database management system 145 decides an appropriate action to take.

For example, at the operation 625, in some embodiments, the database management system 145 may decide to add additional storage to the cluster on which the database is located. In some embodiments, the database management system 145 may decide to move the database to another cluster. In some embodiments, the database management system 145 may notify the user that the database has run out of space or is to expected to run out of space soon. The database management system 145 may then receive input from the user instructing the database management system to take specific action (e.g., move the database, add more storage to the cluster, do nothing, etc.).

At operation 630, the database management system 145 takes the action that was decided at the operation 630. For example, upon determining that the database needs to be moved to a new location, the database management system 145 determines a new location for moving the database (e.g., using the process 500) and moves the database to that new location. The new location may be another cluster in the same datacenter or another datacenter. If the database management system 145 is to add more storage to the cluster, the database management system may take action to facilitate adding additional storage. The process 600 ends at operation 635.

In some embodiments, the database management system 145 may decide whether to move the database to another datacenter and/or cluster if the database management system determines that another more suitable cluster is available. In some embodiments, if the database was created on a particular datacenter and another datacenter becomes available that is closer to the location of access of the database, the database management system 145 may decide to move the database to the new datacenter. For example, if the database was initially created on a datacenter in New York but was being accessed from San Francisco, if a datacenter becomes available near San Francisco, the database management system 145 may move the database to that datacenter near San Francisco to reduce network latency, particularly if the other criteria for an optimal database are also satisfied (e.g., datacenter has suitable clusters as discussed above).

In some embodiments, the database management system 145 may move the database to another cluster based on the cost of operating the database on the cluster. For example, if the database is provisioned on Cluster A and the cost of operating the database on Cluster A is X, when the database management system 145 determines that Cluster B has a cost of operation Y that is lower than X and satisfies other criteria for which Cluster A was initially selected, the database management system may move the database to Cluster B. In other embodiments, the database management system 145 may similarly decide to move the database to other optimal clusters based on other conditions.

Thus, the present disclosure provides an easy and convenient mechanism to provision databases in a manner that increases the efficiency and performance of the databases. Furthermore, the databases are monitored to ensure that the databases continue to operate optimally after provisioning. If decrease in the performance of a database is identified or anticipated, the database may be moved to a different location where the database may continue to operate optimally. Further, by selecting an appropriate location for the database, the present disclosure avoids the need for the user to determine the proper location of the database. The user need not worry about whether the cluster on which the database is to be provisioned will have enough storage space and resources or not.

Specifically, the present disclosure provides mechanisms for database automation and lifecycle management natively integrated into the database management system. With the present disclosure, databases may be defined via simple blueprints (e.g., pre-defined rules) that may be easily created using industry standard skills and control all aspects of the database’s lifecycle, such as provisioning, copy data management, scaling, and cleanup. These blueprints may be created through the dashboard or via code (e.g., using a Python-based DSL), including seamless conversion. Once created, a blueprint may be easily published to end users, instantly transforming a complex provisioning process into a simple one-click request. The present disclosure, thus, provides a single language for database modeling with flexibility to integrate with each team’s tool of choice unified management and governance across clouds, on-premise, and datacenters, removes bottlenecks by turning specialized operations into push-button automation, provides automated self-service for users to easily and conveniently build and manage databases.

The present disclosure also simplifies the set-up and management of databases by incorporating all elements of each database, including relevant VMs, configurations, and related binaries, into an easy-to-use blueprint that is managed by the users. The blueprints may be easily managed (e.g., edited) via the dashboard (e.g., GUI or command line interface), depending on a user’s preference. By making the deployment and lifecycle management of databases both automated and easily repeatable, users may eliminate the hours and days currently devoted to routine database management. In some embodiments, the present disclosure may provide pre-defined blueprints that the user may select from to create the pre-defined rules. In other embodiments, the blueprints may be custom defined from scratch or pre-defined blueprints may be modified to suit a user’s purposes. Thus, blueprints or pre-defined rules may provide a framework or template to describe one or more steps for provisioning and otherwise managing databases. Therefore, the blueprints streamline the provisioning and management of databases.

The present disclosure may be used to empower different groups in an organization to provision and manage their own databases, thereby providing powerful, database-centric self-service capabilities with role-based access control. All activities and changes may be logged for end-to-end traceability, aiding security teams with key compliance initiatives. The present disclosure provides the tools required to modernize databases without losing control of policy. The present disclosure automates the provisioning of databases not only across datacenters, but also across multi-cloud architectures, scaling both multi-tiered and distributed databases across different cloud environments. The present disclosure allows tracking and monitoring the overall utilization and true cost of consumption at a glance providing the information required to make deployment decisions with confidence. The present disclosure converts database management into a resilient, software-defined solution with rich machine intelligence. The result is predictable performance, cloud-like infrastructure consumption, robust security, and seamless application mobility for a broad range of databases.

By autonomously selecting optimal locations for databases and continuously monitoring and taking actions based on the monitoring, the present disclosure provides intelligent resource sizing and accurate visibility into cloud metering and chargebacks, while ensuring continuous optimal performance of the databases. The present disclosure allows users to gain visibility into the database usage pattern to precisely identify performance bottlenecks. In some embodiments, the database management system may leverage machine learning and artificial intelligence to provide real-time visibility in the database usage pattern across various datacenters and platforms (e.g., on-premise, cloud, multi cloud, hybrid cloud, etc.). Thus, in some embodiments, the present disclosure provides a unified visibility across various datacenters and platforms, along with automated database management.

Thus, the present disclosure empowers a user to deliver and manage production ready databases with push-button simplicity while preserving native user experience. The present disclosure provides visibility into database usage pattern at an aggregate and granular level. The database management system automatically identifies usage anomalies and provides optimization of database performance by providing recommendations to easily right-size database resources. The database management system may use machine intelligence to continuously suggest optimal locations for databases. In some embodiments, the database management system may enable setting database usage pattern policies that continuously track the database usage provide alerts to users when the usage exceeds a threshold. In some embodiments, the database management system may generate usage report for user review. In some embodiments, the database management system may project or predict (e.g., using machine learning/artificial intelligence) usage of a database for the upcoming predetermined time period (e.g., next week, next months, etc.). In some embodiments, the database management system may consider historical database usage patterns in predicting future usage patterns. For example, in some embodiments, the database management system may consider the last X days of usage in projecting a usage pattern for the next Y days.

It is to be understood that any examples used herein are simply for purposes of explanation and are not intended to be limiting in any way. It is also to be understood that any examples used herein are simply for purposes of explanation and are not intended to be limiting in any way. Further, although the present disclosure has been discussed with respect to memory usage, in other embodiments, the teachings of the present disclosure may be applied to adjust other resources, such as power, processing capacity, etc.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected," or "operably coupled," to each other to achieve the desired functionality, and any two components capable of being so associated can also be viewed as being "operably couplable," to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as "open" terms (e.g., the term "including" should be interpreted as "including but not limited to," the term "having" should be interpreted as "having at least," the term "includes" should be interpreted as "includes but is not limited to," etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to inventions containing only one such recitation, even when the same claim includes the introductory phrases "one or more" or "at least one" and indefinite articles such as "a" or "an" (e.g., "a" and/or "an" should typically be interpreted to mean "at least one" or "one or more"); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of "two recitations," without other modifiers, typically means at least two recitations, or two or more recitations). Furthermore, in those instances where a convention analogous to "at least one of A, B, and C, etc." is used, in general such a construction is intended in the sense one having skill in the art would understand the convention (e.g., "a system having at least one of A, B, and C" would include but not be limited to systems that have A alone, B alone, C alone, A and B together, A and C together, B and C together, and/or A, B, and C together, etc.). In those instances where a convention analogous to "at least one of A, B, or C, etc." is used, in general such a construction is intended in the sense one having skill in the art would understand the convention (e.g., "a system having at least one of A, B, or C" would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase "A or B" will be understood to include the possibilities of "A" or "B" or "A and B." Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method comprising:
receiving, by a processor of a database management system, data indicating a usage pattern of a database provisioned at a current host location;
applying, by the processor, a machine learning model to the data indicating the usage pattern to generate a predicted database size of the database;
in response to the predicted database size exceeding a predetermined threshold relative to an amount of available space on the current host location, autonomously determining, by the processor, a suggested host location for the database; and
in response to the suggested host location is different from the current host location, autonomously moving, by the processor, the database at the suggested host location.

2. The method of claim 1, further comprising:
predicting, by the processor using the machine learning model, a future usage pattern of the database based on the data indicating the usage pattern, wherein determining the suggested host location is based at least on the predicted future usage pattern.

3. The method of claim 1, wherein the usage pattern comprises at least one of a change in size of the database, a frequency of access to the database, or a location from which the database is accessed.

4. The method of claim 1, further comprising generating, by the processor, a usage report based on the data indicating the usage pattern.

5. The method of claim 1, further comprising:
analyzing, by the processor, a new usage pattern of the database at the suggested host location after moving the database to the suggested host location;
applying, by the processor, the machine learning model to the new usage pattern to generate an updated predicted database size;
in response to the updated predicted database size exceeding the predetermined threshold relative to an amount of available space on the suggested host location, autonomously determining, by the processor, a further suggested host location for the database; and
in response to the further suggested host location being different from the suggested host location, autonomously moving, by the processor, the database to the further suggested host location.

6. The method of claim 1, wherein the predetermined threshold is based at least on a predicted performance of the database at the current host location.

7. The method of claim 6, wherein the predicted performance of the database comprises at least one of a predicted latency and a predicted input/output operations per second.

8. A system comprising:
a memory having computer-readable instructions stored thereon; and
a processor of a database management system executing the computer-readable instructions to:
receive data indicating a usage pattern of a database provisioned at a current host location;
apply a machine learning model to the data indicating the usage pattern to generate a predicted database size of the database;
in response to the predicted database size exceeding a predetermined threshold relative to an amount of available space on the current host location, autonomously determine a suggested host location for the database; and
in response to the suggested host location being different from the current host location, autonomously move the database to the suggested host location.

9. The system of claim 8, wherein the processor further executes computer-readable instructions to:
predict, using the machine learning model, a future usage pattern of the database based on the data indicating the usage pattern, wherein determining the suggested host location is based at least on the predicted future usage pattern.

10. The system of claim 8, wherein the usage pattern comprises at least one of a change in size of the database, a frequency of access to the database, or a location from which the database is accessed.

11. The system of claim 8, wherein the processor further executes computer-readable instructions to generate a usage report based on the data indicating the usage pattern.

12. The system of claim 8, wherein the processor further executes computer-readable instructions to:
analyze a new usage pattern of the database at the suggested host location after moving the database to the suggested host location;
apply the machine learning model to the new usage pattern to generate an updated predicted database size;
in response to the updated predicted database size exceeding the predetermined threshold relative to an amount of available space on the suggested host location, autonomously determine a further suggested host location for the database; and
in response to the further suggested host location being different from the suggested host location, autonomously move the database to the further suggested host location.

13. The system of claim 8, wherein the predetermined threshold is based at least on a predicted performance of the database at the current host location.

14. The system of claim 13, wherein the predicted performance of the database comprises at least one of a predicted latency and a predicted input/output operations per second.

15. A non-transitory computer-readable medium comprising computer-readable instructions stored thereon that when executed by a processor of a database management system cause the processor to:
receive data indicating a usage pattern of a database provisioned at a current host location;
apply a machine learning model to the data indicating the usage pattern to generate a predicted database size of the database;
in response to the predicted database size exceeding a predetermined threshold relative to an amount of available space on the current host location, autonomously determine a suggested host location for the database; and
in response to the suggested host location being different from the current host location, autonomously move the database to the suggested host location.

16. The non-transitory computer-readable medium of claim 15, wherein the computer-readable instructions when executed by the processor further cause the processor to:
predict, using the machine learning model, a future usage pattern of the database based on the data indicating the usage pattern, wherein determining the suggested host location is based at least on the predicted future usage pattern.

17. The non-transitory computer-readable medium of claim 15, wherein the usage pattern comprises at least one of a change in size of the database, a frequency of access to the database, or a location from which the database is accessed.

18. The non-transitory computer-readable medium of claim 15, wherein the computer-readable instructions when executed by the processor further cause the processor to generate a usage report based on the data indicating the usage pattern.

19. The non-transitory computer-readable medium of claim 15, wherein the computer-readable instructions when executed by the processor further cause the processor to:
analyze a new usage pattern of the database at the suggested host location after moving the database to the suggested host location;
apply the machine learning model to the new usage pattern to generate an updated predicted database size;
in response to the updated predicted database size exceeding the predetermined threshold relative to an amount of available space on the suggested host location, autonomously determine a further suggested host location for the database; and
in response to the further suggested host location being different from the suggested host location, autonomously move the database to the further suggested host location.

20. The non-transitory computer-readable medium of claim 15, wherein the predetermined threshold is based at least on a predicted performance of the database at the current host location.

21. The non-transitory computer-readable medium of claim 20, wherein the predicted performance of the database comprises at least one of a predicted latency and a predicted input/output operations per second.
